(19) United States
(12) Patent Application Publication
(10) Pub. No.: US 2006/0144201 A1
(43) Pub. Date: Jul. 6, 2006

(54) Adjustable rotating shaft guard

(75) Inventor: Ronald J. Doll, Cedarburg, WI (US)

Correspondence Address: CARLSON, GASKEY & OLDS, P.C., 400 WEST MAPLE ROAD, SUITE 350, BIRMINGHAM, MI, 48009, US

(73) Assignee: The Falk Corporation

(21) Appl. No.: 11/030,240

(22) Filed: Jan. 6, 2005

(51) Int. Cl. B26D 1/00

(52) U.S. Cl. 83/13

(57) ABSTRACT

A rotating shaft guard assembly includes a first guard portion, a second guard portion and an end cap. A rectilinear portion defines a generally flat leg receipt area to mount a leg selected from one of a multitude of legs. The end cap is mountable to a semi-cylindrical guard portion in a press-fit manner. The end cap includes a stepped pyramid end which provide a shaft exit of a predetermined diameter by cutting off the circular steps which are smaller than the desired shaft diameter exit.

### BACKGROUND OF THE INVENTION

The present invention relates generally to guards for rotating machinery and more particularly to an adjustable rotating shaft guard which may be modified to accommodate different shaft heights and lengths.

Various machines utilize exposed rotational shafts such as the shaft between an electric motor and a pump. These rotating shafts are commonly shielded to maintain compliance with current safety standards.

Although numerous effective guard systems are currently available, most guards are custom made specifically for a particular piece of machinery. Manufacturing custom guards may be time consuming and expensive. Furthermore, many guards once installed do not provide ready access to the rotating components. Removal of the guards increases maintenance complexity and service expense.

Effective universal guard systems are also available which may be adapted to cover a variety of rotating shaft arrangements. Conventional universal guard system provides various manufacturing, assembly, installation and maintenance trade-offs.

Accordingly, it is desirable to provide an adjustable rotating shaft guard which may be readily modified to fit different machines, be uncomplicated to assemble, and provide ready maintenance access.

### SUMMARY OF THE INVENTION

A rotating shaft guard assembly according to the present invention includes a first guard portion and a second guard portion defined along a longitudinal axis. The guard portions are symmetrical with a semi-cylindrical portion which extends from a rectilinear portion. The first guard portion and the second guard portion are mounted together along a hinge which defines a hinge line generally parallel to the longitudinal axis.

A multitude of radial cutting lines are formed about the semi-cylindrical portions to customize the longitudinal length of the guard. The rectilinear portions define a generally flat leg receipt area to which a leg selected from one of a multitude of legs is attached to customize the height of the guard.

An end cap is mountable to the semi-cylindrical portion in a press-fit manner. The end cap includes a multitude of circular steps defined about the longitudinal to essential form a stepped pyramid end. Each circular step provides a shaft exit of a predetermined diameter to customize the shaft diameter exit.

The present invention therefore provides an adjustable rotating shaft guard which may be readily modified to fit different machines, is uncomplicated to assemble, while providing ready maintenance access.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general view an exemplary machine for use with the present invention;

FIG. 2 is a perspective view of a rotating shaft guard assembly of the present invention;

FIG. 3 is a side view of a rotating shaft guard assembly of the present invention;

FIG. 4 is a top view of a rotating shaft guard assembly of the present invention;

FIG. 5 is a bottom view of a rotating shaft guard assembly of the present invention;

FIG. 6 is a side view of a multiple of legs for use with the shaft guard assembly;

FIG. 7 is a side view of a backing plate for the legs of FIG. 6; and

FIG. 8 is an end view of a rotating shaft guard assembly of the present invention.

### DETAILED DESCRIPTION OF THE PREFERRED EMBODIMENT

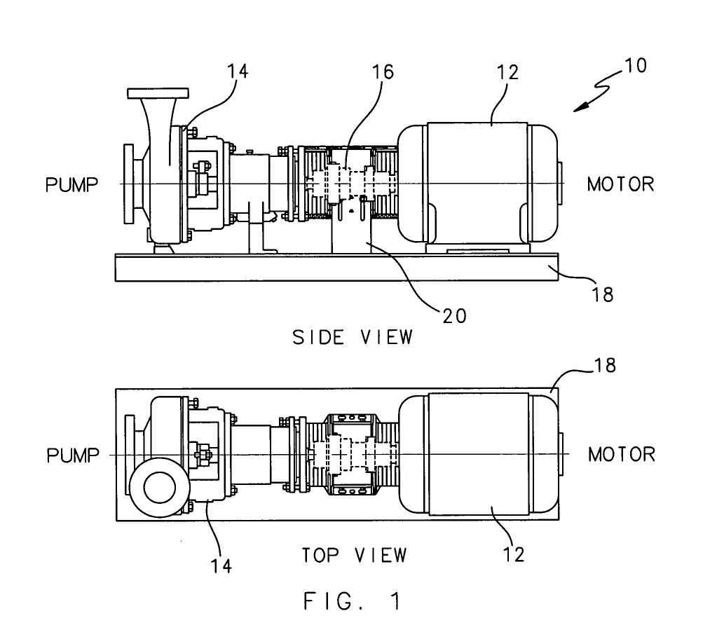

FIG. 1 illustrates a general side view of a machine 10 having a prime mover such as an electric motor 12 and a driven machine such as a pump 14 interconnected by a rotating shaft assembly 16. The motor 12 and pump 14 are supported upon a base 18. It should be understood that although a particular component arrangement is disclosed in the illustrated embodiment, other arrangements will benefit from the instant invention.

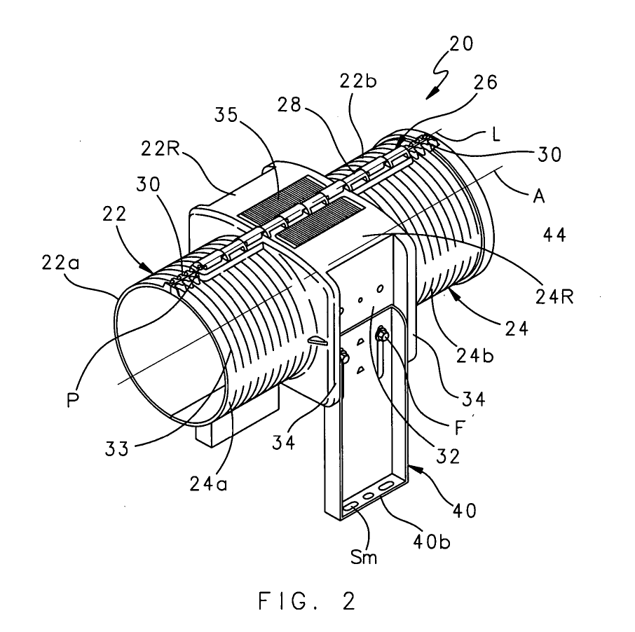

Referring to FIG. 2, a rotating shaft guard assembly 20 is illustrated. The shaft guard assembly 20 is preferably manufacture of a high-impact polyethylene plastic which is colored a bright color such as orange. The rotating shaft guard assembly 20 includes a first guard portion 22 and a second guard portion 24 defined along a longitudinal axis A. The guard portions 22, 24 are preferably symmetrical and each include a semi-cylindrical portion 22a, 22b 24a, 24b extending from a rectilinear portion 22r, 24r. The semi-cylindrical portion 22a, 22b 24a, 24b extend along the longitudinal axis from each side of the rectilinear portion 22r, 24r.

The first guard portion 22 and the second guard portion 24 are mounted together along a hinge 26 which defines a hinge line L generally parallel to and within a common plane with the longitudinal axis A. The hinge 26 is preferably defined along a top surface of the first guard portion 22 and the second guard portion 24. The hinge 26 is defined by a multiple of hinge knuckles 28 which alternate along the first guard portion 22 and the second guard portion 24. That is, the knuckles alternate along a top edge surface of the first guard portion 22 and a second guard portion 24 such that a pin P which passes through all the knuckles 28 pivotally connect the first guard portion 22 and the second guard portion 24. The portions 22, 24 preferably fit together with gaps no greater than 0.250″ (6 mm).

A multitude of stiffening ribs 30 extend along the hinge line L outward of the hinge 26. The stiffening ribs 30 are generally transverse to the hinge line L.

A multitude of radial cutting lines 33 are preferably formed about the semi-cylindrical portion 22a, 22b 24a, 24b. The cutting lines 33 are preferably shallow depressions formed in the outer surface to provide a guide for cutting the first and second guard halves to reduce the longitudinal length along axis A for custom installations such as between the motor 12 and the pump 14 (FIG. 1). It should be understood that any number of cutting lines 33 at any desired increment may be provided.

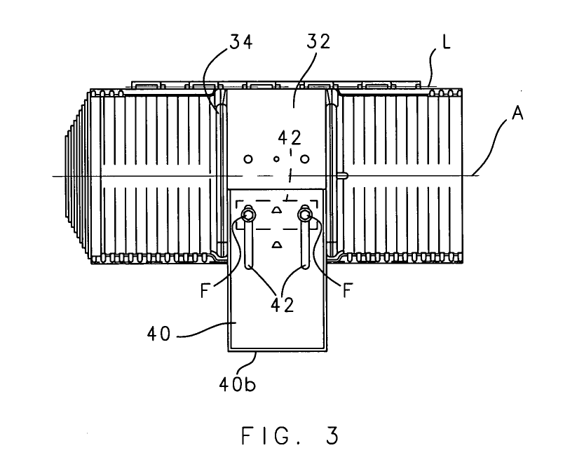

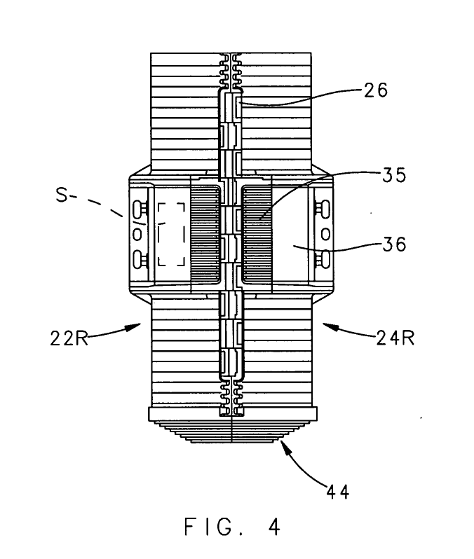

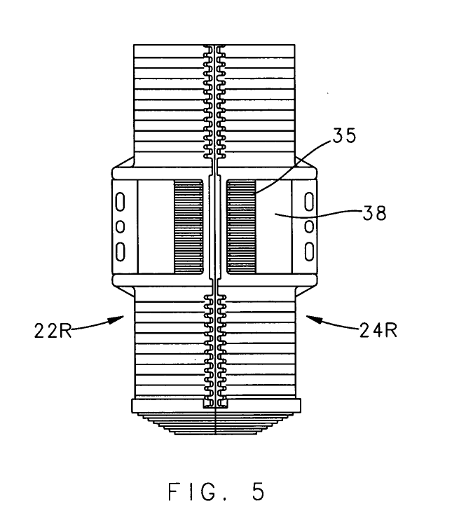

The rectilinear portions 22r, 24r define a generally flat leg receipt area 32. The leg receipt area 32 is defined by outer ribs 34 generally perpendicular to the longitudinal axis A (also illustrated in FIG. 3). A multitude of vents 35 are preferably located through a top surface 36 (FIG. 4) and a bottom surface 38 (FIG. 5) of the rectilinear portion 22r, 24r to provide airflow and inspection. Safety labels S (FIG. 4) are preferably molded directly into the top surface 36 to provide compliance with OSHA, ASME, and ANSI standards.

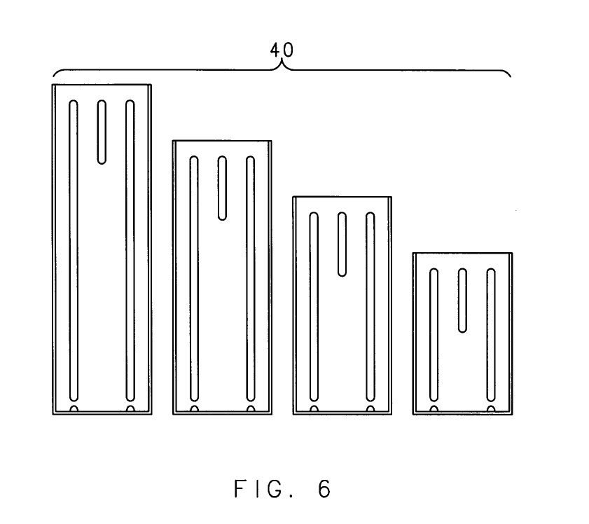

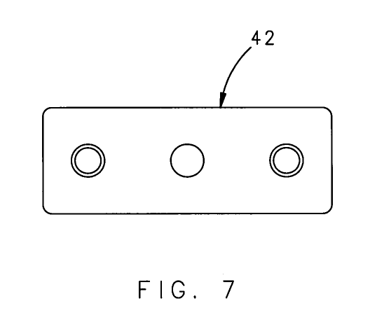

A leg 40 is selected from one of a multitude of legs 40 (FIG. 6) and attached to the flat leg receipt area 32 with fasteners F such as bolts or the like. The fasteners F preferably mount to a corresponding backing plate 42 (FIG. 7) which is located on the opposite side of the flat leg receipt area 32 within the rectilinear portions 22r, 24r (FIG. 3).

Each leg 40 is preferably of a general U-shape to fit between the outer ribs 34. A pair of slots 42 permit height adjustment of the guard assembly 20 relative the base 18. The slots 42 combined with the multitude of legs (FIG. 6) to provide a relatively large height adjustment.

Each leg 40 also includes a base 40b with a multiple of mounting slots Sm. The mounting slots Sm receive fasteners F such as bolts to mount the guard assembly 20 to the base 18 (FIG. 1). The pair of slots 42 combined with the U-shape of the leg 40 and the outer ribs 34 provide a stable guard assembly 20 to base 18 mounting arrangement which preferably resists at least a 250 pound load without significant deflection.

An end cap 44 (one shown) is mountable to the semi-cylindrical portion 22a, 22b 24a, 24b. The end cap 44 preferably engages the multitude of stiffening ribs 30 in a press-fit manner (FIG. 4). It should be understood that any friction fit arrangement will also be usable with the present invention.

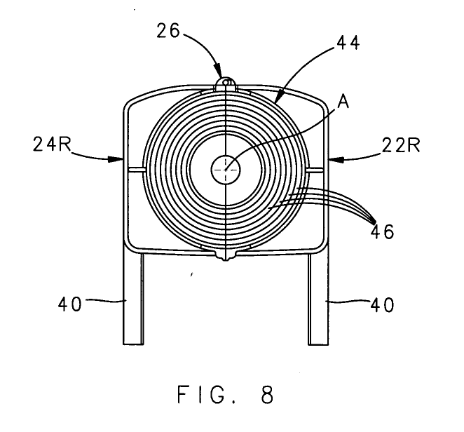

Referring to FIG. 8, the end cap 44 includes a multitude of circular steps 46 defined about axis A. The multitude of circular steps 46 essentially form a stepped pyramid (best seen in FIG. 3). Each circular step 46 provides a shaft exit of a predetermined diameter. That is, the desired diameter is determined and the outer circular steps 46 smaller than the desire diameter are cut off thereby providing a symmetrical finished diameter shaft exit. It should be understood that any number of circular steps may be provided depending upon the desired shaft opening increments.

To install the rotating shaft guard assembly 20, a longitudinal distance between the prime mover 12 and the driven machine 14 which covers the rotating shaft assembly 16 (FIG. 1) is determined and the radial cutting line 33 associated therewith is cut through. The desired diameter for the shaft exit is determined and the outer circular steps 46 smaller than the desire diameter are cut off thereby providing a symmetrical finished diameter shaft exit. The guard portions 22,24 are pivoted over the shaft assembly 16 and the end cap is then mounted over the end of the shaft assembly 16 preferably on the driven machine 14 side and friction fit to the portions 22, 24. The desired height of the guard assembly 20 is determined and the appropriate leg 40 is selected (FIG. 6) and mounted to the leg receipt areas 32. The driven machine 14 is then mounted to the base 18 and final height is adjusted by shifting the housing portions 22, 24 within the slots 42 formed through the legs 40.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An adjustable rotating shaft guard assembly comprising:
a first guard portion;
a second guard portion mountable to said first guard portion along a hinge line, said hinge line located along a hinge axis parallel to a longitudinal axis defined by said first and second guard portion; and
an end cap mountable to said first guard portion and said second guard portion.

2. The adjustable rotating shaft guard assembly as recited in claim 1, wherein said first guard portion is symmetrical to said second guard portion.

3. The adjustable rotating shaft guard assembly as recited in claim 1, wherein said first guard portion and said second guard portion include a rectilinear portion and a semi-circular guard portion extending from said rectilinear portion.

4. The adjustable rotating shaft guard assembly as recited in claim 3, further comprising a vent formed through said rectilinear portion adjacent said hinge line.

5. The adjustable rotating shaft guard assembly as recited in claim 3, wherein said rectilinear portion forms a leg receipt area.

6. The adjustable rotating shaft guard assembly as recited in claim 5, further comprising a leg mountable to said leg receipt area.

7. The adjustable rotating shaft guard assembly as recited in claim 6, wherein said leg is selected from a multitude of legs of differing lengths.

8. The adjustable rotating shaft guard assembly as recited in claim 3, further comprising a plurality of cutting lines formed on said semi circular guard portion.

9. The adjustable rotating shaft guard assembly as recited in claim 1, wherein said hinge line includes a multiple of knuckles which alternate between said first guard portion and said second guard portion.

10. The adjustable rotating shaft guard assembly as recited in claim 1, wherein said end cap includes a stepped end.

11. The adjustable rotating shaft guard assembly as recited in claim 1, wherein said end cap includes a stepped pyramid end each of a different diameter.

12. The adjustable rotating shaft guard assembly as recited in claim 1, wherein said cap includes a multitude of circular steps.

13. The adjustable rotating shaft guard assembly as recited in claim 12, wherein each of said circular steps define a shaft diameter.

14. The adjustable rotating shaft guard assembly as recited in claim 1, wherein said first guard portion and said second guard portion include a multitude of stiffening ribs to engage said end cap.

15. The adjustable rotating shaft guard assembly as recited in claim 14, wherein said stiffening ribs are defined along said hinge axis.

16. An adjustable rotating shaft guard assembly comprising:
a first guard portion including a first rectilinear portion and a semi-circular guard portion extending from said first rectilinear portion;
a second guard portion including a second rectilinear portion and a second semi-circular guard portion extending from said second rectilinear portion;
a hinge line located along a hinge axis parallel to a longitudinal axis defined by said first and second guard portion, said hinge line including a multitude of knuckles extending from said first guard portion and said second guard portion; and
an end cap engageable with said first semi-circular guard portion and said second semi-circular guard portion.

17. The adjustable rotating shaft guard assembly as recited in claim 16, wherein said first rectilinear portion and said second rectilinear portion each define a leg receipt area.

18. The adjustable rotating shaft guard assembly as recited in claim 17, further comprising a leg having a slot to slidably adjust said leg relative said leg receipt area to define a height of said adjustable shaft guard relative to a base.

19. The adjustable rotating shaft guard assembly as recited in claim 18, wherein said hinge line is located opposite said base.

20. A method of assembling an adjustable rotating shaft guard assembly comprising the steps of:
(1) cutting off at least one of a multitude of circular steps defined about a longitudinal axis of an end cap to form a shaft opening of a desired diameter; and
(2) mounting the end cap to a first and a second guard portion.

21. A method as recited in claim 20, further comprising the step of:
hinging the first guard portion relative the second guard portion.

22. A method as recited in claim 20, further comprising the steps of:
sliding a first leg relative the first guard portion and a second leg relative the second guard portion to a desire height; and
mounting the first leg to the first guard portion and the second leg to the second guard portion.
